(19) United States
(12) Patent Application Publication
(10) Pub. No.: US 2005/0212912 A1
(43) Pub. Date: Sep. 29, 2005

(54) System and method for wildlife activity monitoring

(76) Inventor: Faron Huster, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/811,218

(22) Filed: Mar. 26, 2004

(51) Int. Cl. H04N 7/18

(52) U.S. Cl. 348/155; 348/143; 348/164

(57) ABSTRACT

A system for wildlife activity monitoring in a remote location comprising a microprocessor, an image capture portion operatively connected to the microprocessor that captures an image from a field of view, a motion detector attached to the microprocessor that provides a signal to the microprocessor indicating when an animal is detected within the field of view, a memory operatively connected to the microprocessor for storing images captured by the image capture portion, and a communications portion operatively attached to the microprocessor wherein the communications portion transmits the images to a host computer upon the happening of a triggering event.

### FIELD OF THE INVENTION

The invention relates to the field of wildlife management. More specifically, the invention relates to a system and method for monitoring wildlife to track wildlife activity and habits.

### SUMMARY OF THE INVENTION

A system for wildlife activity monitoring in a remote location comprising a microprocessor, an image capture portion operatively connected to the microprocessor that captures an image from a field of view, a motion detector attached to the microprocessor that provides a signal to the microprocessor indicating when an animal is detected within the field of view, a memory operatively connected to the microprocessor for storing images captured by the image capture portion, and a communications portion operatively attached to the microprocessor wherein the communications portion transmits the images to a host computer upon the happening of a triggering event or at a predetermined time set by the user.

### BRIEF DESCRIPTION OF THE DRAWINGS

FIG. 1 is a diagram of the system of the present invention; and

FIG. 2 is a diagram of a camera according to the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention generally comprises a system that allows hunters, landowners and others the ability to track and monitor wild game movement on privately held land or for the use of government agencies on public ground. The system operates by sensing movement and taking either a still picture of an area in which movement is sensed or recording full motion video of the area in which the movement was sensed. For the purposes of the present disclosure, the term “image” or “images” will be used to refer to both full motion video and still images. The images are then stored and transmitted at a predetermined time or after a predetermined number of images have been taken. At the time of transmission, the images are transmitted wirelessly to a central location. The central location may consist of a computer operated by the hunter or landowner or, more preferably, a computer operated by a hosting service. The hosting service, after receiving the images, then makes the images available to subscribers and will provide a notification to the subscriber that new images are available at the hosting service. The subscriber would then log on to the hosting service in order to view the images.

The hosting service provides the images to the user in a format which allows the subscriber to easily associate the images with the time and date taken, such as in the form of a calendar or journal having icons indicating when the image was taken and allowing the subscriber to select the icon to view the image. Additionally, the hosting service 40 would provide other information of use to the subscriber tracking wildlife, such as sunrise, sunset, general weather data for the location (i.e. temperature, rainfall, wind speed and direction, etc.), moon phases, moon rise, moon set, moon declination angle, aerial and topographical mapping of the location, as well as general hunting and conservation tips. The hosting service 40 also allows the user to map locations of buck rubs, scrapes, as well as the location of deer stands and food plots. Moreover the hosting service can provide methods for subscribers to allow others to access their data, share recipes incorporating wild game, and discuss hunting and conservation issues. Additionally, the hosting service provides the functionality for the subscriber to make notes regarding the images in order to track animal growth, male to female ratios, overall animal population, animal movement and habits, and trespassing poaching activity.

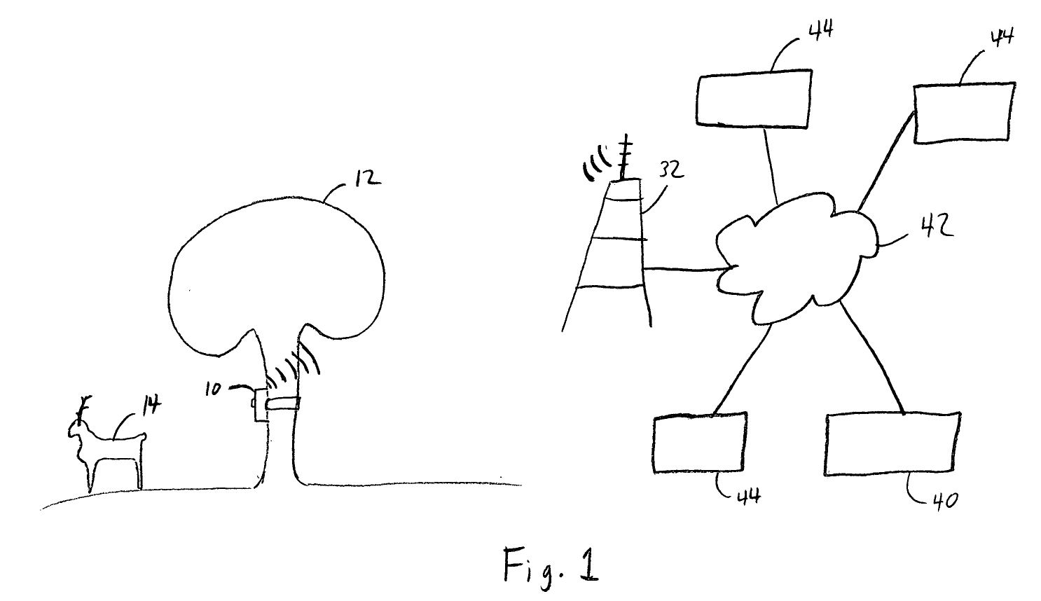

In this regard there is provided in FIG. 1 a camera 10 for capturing still pictures and full motion video of wildlife movement at a remote location. The camera 10 is mounted above the ground to an item such as a tree or post 12. The camera 10 is activated by the movement of an animal 14, in this instance shown in FIG. 1 to be a deer. Movement of the deer 14 is detected by the camera 10, which begins taking video of the deer moving or begins taking a still images of the deer as it moves. Optionally, the images may also be stamp with information about when or where or under what conditions the image was taken, such as the name of the location, the time of day, the weather conditions, or any combination thereof.

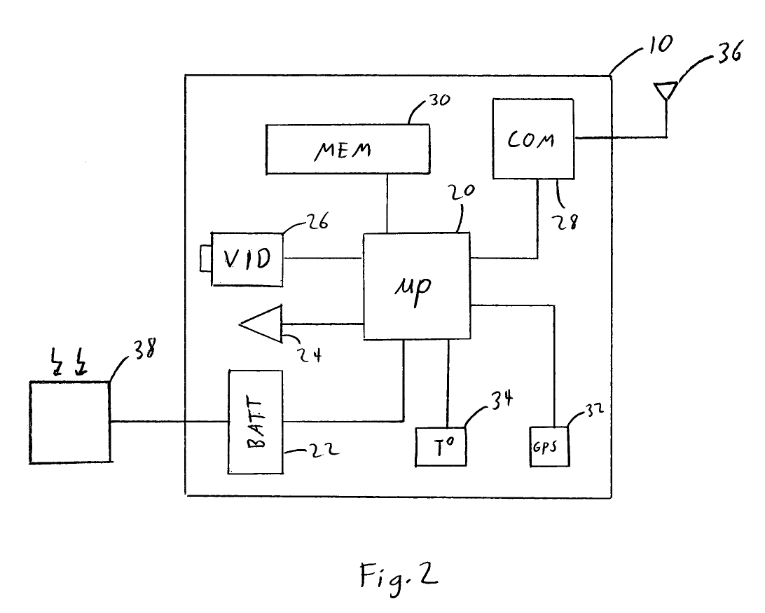

Referring to FIG. 2, the camera 10 comprises a microprocessor 20 powered by a battery 22. The microprocessor 10 is operatively linked to a motion detector 24 which detects motion within a field of view of an image capture portion 26. The image capture portion 26 is further linked to the microprocessor 20. The microprocessor 20 is also operatively linked to a communications portion 28. The communications portion 28 is connected to an antenna 36. A bank of memory 30 receives images taken by the image capture portion 26 from the microprocessor 20 that are queued to be transmitted at a later time.

The motion detector 24 may be of any type, but preferably by itself or with the microprocessor 20, is capable of discriminating undulating motion from relevant motion. The motion detector can work using radio frequency motion detection (i.e. Doppler effect) or infra-red heat detection to detect the presence of a warm body of a person, animal or vehicle or by breaking the path of an infrared beam. By discriminating undulating motion from relevant motion, the detector 24 can discriminate motion of a person, animal, vehicle, etc. (i.e. relevant motion) from the undulating motion of a tree branch being blown in the wind. Regardless, the detector 24 alerts the microprocessor when motion associated with a person, animal, vehicle, etc. is present.

Upon receiving a signal that relevant motion is present within the field of range of the detector 24, the microprocessor 20 signals the image capture portion 26 to begin capturing images of its field of view. The images are communicated to the microprocessor 20, which, in turn, communicates the images to the memory 30. The microprocessor 20 further optionally alter the images to include indicia representing information about when, where and under what conditions the image was captured, such as but not limited to time and date, current camera location and current weather data.

The microprocessor 20 monitors the memory to determine when the memory 30 is full. When the detector 24 no longer detects relevant motion, the detector 24 ceases indicating to the microprocessor 20 that relevant motion is present. A predetermined period of time after the detector 24 has ceased indicating relevant motion, the microprocessor 20 causes the image capture portion 26 to cease recording images. The predetermined period of time is preferably user adjustable from a remote location, as discussed below, or is predetermined and set at the time of unit setup. The predetermined period of time is necessary in order to continue recording images of an animal that has momentarily stopped moving but remains within the image capture portion's field of view.

The microprocessor 20 will communicate the stored images within the memory 30 to the communications portion 28 upon the happening of one or more of several triggering events. For example, a first triggering event is the memory 30 filling to its capacity. A second triggering event is the passing of a predetermined time of day. A third triggering event is the passage of a predetermined length of time from a previous triggering event. A fourth triggering event is a command received from a remote location to transmit the contents of the memory 30. A fifth triggering event is the cessation of an indication from the detector 24 that motion is present. A sixth triggering event is the initiation of an indication from the detector 24 that motion is present.

Upon the happening of a triggering event, the communications portion 28 initiates contact with a communication access point 32 . The communication access point 32 is preferably, but not limited to, a wireless communication tower, as shown in FIG. 1. Preferably, the data communication method is via general packet radio system (GPRS). GPRS is a data transmission technique that does not set up a continuous channel from a portable terminal for the transmission and reception of data, but transmits and receives data in packets. It makes very efficient use of available radio spectrum, and users pay only for the volume of data sent and received. However, other wireless or wire-bound data transmission techniques may be used without departing from the scope of the present invention and may be selected based upon factors such as cost and availability of other services. After the images have been transmitted, the microprocessor 20 erases the stored images from the memory 30.

Referring back to FIG. 2, the camera 10 may optionally further comprise a global positioning sensor (GPS) 32. The GPS 32 is connected to the microprocessor 20 and is operated by the microprocessor 20 to occasionally determine whether the camera has been moved to a new location. If the GPS 32 determines that the camera 10 has been moved, the coordinates of the current location are stored in the memory 30 and transmitted to the hosting service 40 upon the next triggering event. In this manner the hosting service can provide relevant information about the location of the camera 10 to a subscriber, as explained below. Additionally, the GPS 32 can help locate the camera should the camera 10 be stolen.

An optional compass is proved for assistance in positioning the camera 10 so that it is not pointed directly into the sun during any part of the day, such that images taken during any part of the day will not be unviewable due to glare.

An optional electronic thermometer 34 may also be provided and attached to the microprocessor 20 to transmit the precise temperature at the location. Other weather detecting devices, such as a humidistat, barometer, rain gauge, wind direction and speed gauge, etc. may also be provided. This information can than be recorded at the exact time of a triggering event and simultaneously stamped on the image to be transmitted along with the image.

The camera 10 can also transmit data about the camera's 10 status, such as the battery power left, the current triggering events enabled, a unique camera identifying number, and any other information about the camera's current status and configuration.

The microprocessor 20 operated the devices 22-28, 32, 34 such that the majority of the time the devices are not constantly operating. Rather, the microprocessor 20 powers up the required device 22-28, 32, 34 only occasionally on time intervals that may be modified in order to conserve battery power. Additionally, the processor may have a power save/hibernate feature that cause s the device to cease operation during times of day or night in which it is unlikely to observe a particular type of wildlife. The memory 30 is of a type that favors energy efficiency over speed, such as complementary metal oxide semiconductor (CMOS) chips. However, other types of nonvolatile memory may be used such as magnetic random access memory or miniature hard drives. Finally, solar cells 38 may be provided to recharge the battery and external batteries provided to increase battery life. For example, a deep cycle lead acid marine battery may be provided and placed at the bottom of the tree 12.

Besides sending location, battery and image information to the hosting service 40, data is received from the hosting service 40 by the camera 10 as well. Specifically, the hosting service 40 can transmit changes in the settings and behavior of the camera 10, such as enable or disable triggering events, change threshold values in motion detection or change power saving features, and thresholds, detect present location or operate or change settings for any other device associated with the camera.

The hosting service 40 receives and transmits images and other information amongst a plurality of cameras 10 located in various locations in the world. The hosting service 40 also provides an interface for subscribers to view images received from their own cameras from using own computers 44 attached to a communication network 42, such as the Internet.

Optionally, the user's own camera 10 could transmit the images and other information directly between a user's computer 40 and itself with the user's own computer performing the same tasks as the hosting service 40. In this configuration, the user's computer 40 operates as a “host” computer.

In view of the above, it will be seen that several advantages of the present invention have been achieved and other advantageous results have been obtained.

1. A system for wildlife activity monitoring in a remote location comprising:
a microprocessor;
an image capture portion operatively connected to the microprocessor that captures an image from a field of view;
a motion detector attached to the microprocessor that provides a signal to the microprocessor indicating when an animal is detected within the field of view;
a memory operatively connected to the microprocessor for storing images captured by the image capture portion; and
a communications portion operatively attached to the microprocessor wherein the communications portion transmits the images to a host computer upon the happening of a triggering event.

2. The system of claim 1 wherein the triggering event is selected from the group consisting of: the memory filling to its capacity, passing of a predetermined time of day, passing of a predetermined length of time from a previous triggering event, a command received from a remote location to transmit the contents of the memory, the cessation of an indication from the detector that motion is present, an initiation of an indication from the detector that motion is present, or any combination thereof

3. The system of claim 1 wherein the triggering event is selected from the group consisting of the memory filling to its capacity, passing of a predetermined time of day, passing of a predetermined length of time from a previous triggering event, a command received from a remote location to transmit the contents of the memory, the cessation of an indication from the detector that motion is present or any combination thereof.

4. The system of claim 1 wherein the microprocessor, the image capture portion, the motion detector, the memory, and the communications portion are powered exclusively by batteries.

5. The system of claim 1 wherein the microprocessor, the image capture portion, the motion detector, the memory, and the communications portion are powered exclusively by batteries and solar energy.

6. The system of claim 1 further comprising a sensor operatively connected to the microprocessor for measuring a parameter of weather at the location of the sensor.

7. The system of claim 6 wherein the sensor is a thermometer.

8. The system of claim 1 further comprising a global positioning sensor operatively connected to the microprocessor for indicating global position coordinates.

9. The system of claim 1 wherein the motion detector is an infrared detector.

10. The system of claim 1 wherein the motion detector is a radio frequency detector utilizing the Doppler effect.

11. A method of monitoring wildlife activity in a remote location comprising the steps of:
providing a camera physically located within the remote location;
detecting the presence of an animal within a field of view of the camera;
capturing images of the animal within the field of view when the presence of the animal is detected;
storing the images within the camera;
automatically electronically transmitting the stored images from the camera to a computer upon the occurrence of a predetermined triggering event.

12. The method of claim 1 wherein the step of the storing the images within the camera further comprises the step of storing the images within a memory within the camera.

13. The method claim 11 further comprising the step of auto-deleting the image from the memory after the step of automatically electronically transmitting the stored images.

14. The method of claim 11 further comprising the step of recording an item of information selected from the group consisting of: location data, weather data, time data or any combination thereof.

15. The method of claim 11 wherein the triggering event is selected from the group consisting of: the memory filling to its capacity, passing of a predetermined time of day, passing of a predetermined length of time from a previous triggering event, a command received from a remote location to transmit the contents of the memory, the cessation of an indication from the detector that motion is present, an initiation of an indication from the detector that motion is present, or any combination thereof

16. The method of claim 11 wherein the triggering event is selected from the group consisting of: the memory filling to its capacity, passing of a predetermined time of day, passing of a predetermined length of time from a previous triggering event, a command received from a remote location to transmit the contents of the memory, the cessation of an indication from the detector that motion is present or any combination thereof.

17. The method of claim 11 wherein the camera is powered exclusively by batteries.

18. The method of claim 11 wherein the camera is powered exclusively by batteries and solar energy.

19. The method of claim 11 further comprising the step of:
detecting a temperature of the remote location; and
automatically electronically transmitting the detected temperature.

20. The method of claim 11 further comprising the step of:
detecting the global position coordinates of the camera; and
automatically electronically transmitting the detected coordinates.

21. The system of claim 11 wherein the camera detects the presence of an animal with an infrared detector.

22. The system of claim 11 wherein the camera detects the presence of a radio frequency detector utilizing the Doppler effect.
